(19) United States
(12) Patent Application Publication
(10) Pub. No.: US 2011/0063316 A1
(43) Pub. Date: Mar. 17, 2011

(54) IMAGE RECEIVING APPARATUS AND IMAGE RECEIVING METHOD

(75) Inventor: Takahiro KIMURA, Fukaya-shi (JP)

(73) Assignee: KABUSHIKI KAISHA TOSHIBA, Tokyo (JP)

(21) Appl. No.: 12/882,022

(22) Filed: Sep. 14, 2010

(30) Foreign Application Priority Data
Sep. 15, 2009 (JP) 2009-213615

(51) Int. Cl. G06F 12/02

(52) U.S. Cl. 345/543

(57) ABSTRACT

According to one embodiment, an image receiving apparatus includes a communication module, a memory, a controller, and an update. The communication module is configured to receive first content based on a first address and second content based on a second address by communicating with an external server. The memory is configured to store the first content and the second content. The controller is configured to control a list display of a first image corresponding to the first content and a second image corresponding to the second content. The update module configured to reacquire the first content based on the first address and update the first image in the list display to a first reacquisition image corresponding to the first content reacquired.

### CROSS-REFERENCE TO RELATED APPLICATIONS

This application is based upon and claims the benefit of priority from Japanese Patent Application No. 2009-213615, filed Sep. 15, 2009; the entire contents of which are incorporated herein by reference.

### FIELD

Embodiments described herein relate generally to an image receiving apparatus and an image receiving method which connect with an external network and receive content (images).

### BACKGROUND

In recent years, broadcast receivers capable of receiving digital television broadcasting have become widely used. For example, broadcast receivers can receive not only digital television broadcasting but also content by connecting to an external network. In addition, the broadcast receivers can receive first content and store a first Web page (image) corresponding to the first content and further receive second content and store a second Web page (image) corresponding to the second content. According to a change-over operation, the broadcast receivers can display the first or second Web page.

Furthermore, Jpn. Pat. Appln. KOKAI Publication No. 2008-54065 has disclosed the technique for displaying not only an electronic program list on the display screen but also a Web page using URL information about the programs displayed in the electronic program list.

The Web page may be updated as time passes. It is inconvenient for the user to carry out an update operation periodically to update the displayed Web page. To overcome this problem, the technique for updating the displayed Web page automatically has been developed.

While the technique for changing the display of Web pages according to a change-over operation has been known as described above, there has been a desire to view a list of Web pages without any change-over operation. When a list of Web pages is displayed in response to such a desire, each page in the list is not necessarily the latest one.

Therefore, it is conceivable that, after the list display of Web pages is changed to the display of a single Web page, the displayed Web page is updated. However, updating in such steps is inefficient.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a schematic block diagram showing an example of a digital television broadcast receiver (or an image receiving apparatus) according to one embodiment.

FIG. 2 shows an example of display screens which separately display images corresponding to instances of content and an example of a display screen which displays images in list form.

FIG. 3 shows an example of a display screen which displays in list form images corresponding to instances of content.

FIG. 4 is a flowchart to explain an example of the process of updating the selected image.

### DETAILED DESCRIPTION

Various embodiments will be described hereinafter with reference to the accompanying drawings.

In general, according to one embodiment, an image receiving apparatus includes a communication module, a memory, a controller, and an update. The communication module is configured to receive first content based on a first address and second content based on a second address by communicating with an external server. The memory is configured to store the first content and the second content. The controller is configured to control a list display of a first image corresponding to the first content and a second image corresponding to the second content. The update module configured to reacquire the first content based on the first address and update the first image in the list display to a first reacquisition image corresponding to the first content reacquired.

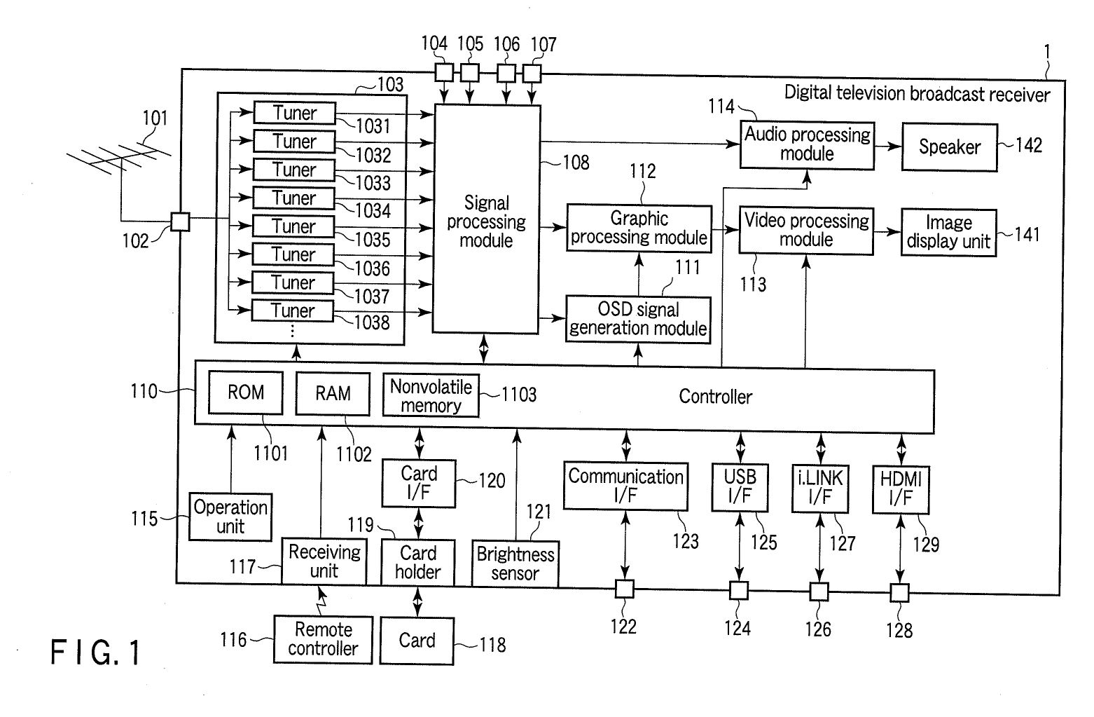

FIG. 1 schematically shows the configuration of a digital television broadcast receiver (or an image receiving apparatus) according to an embodiment. As shown in FIG. 1, the digital television broadcast receiver 1 comprises an antenna 101, an input terminal 102, a tuner unit 103, external input terminals 104 to 107, a signal processing module 108, a controller 110, an OSD signal generation module 111, a graphic processing module 112, a video processing module 113, an audio processing module 114, an operation unit 115, a receiving unit 117, a card holder 119, a card interface 120, a brightness sensor 121, a LAN terminal 122, a communication interface 123, a USB terminal 124, a USB interface 125, an iLINK terminal 126, an iLINK interface 127, an HDMI terminal 128, an HDMI interface 129, an image display unit 141, and a speaker 142.

The tuner unit 103 includes not only terrestrial digital television broadcast tuners 1031 to 1038 but also a digital direct-broadcasting-by-satellite (DBS) television tuner. The tuner unit 103 can receive and display a terrestrial digital television program list corresponding to terrestrial digital television broadcasting by means of the terrestrial digital television broadcast tuners 1031 to 1038. In addition, the tuner unit 103 can receive and display a program list corresponding to digital DBS television with the digital DBS television tuner.

In the embodiment, a case where the digital television broadcast receiver 1 includes the image display unit 141 and speaker 142 as shown in FIG. 1 will be explained. That is, a case where a program information display control apparatus of the embodiment includes the image display unit 141 and speaker 142 will be explained. However, the program information display control apparatus is not limited to such a configuration. For example, the program information display control apparatus may be configured to include neither the image display unit 141 nor speaker 142. In other words, the program information display control apparatus may be configured to connect with the image display unit 141 and speaker 142 via connection means, such as HDMI.

Hereinafter, the digital television broadcast receiver 1 will be explained in detail.

The terrestrial digital television broadcast signal received by the antenna 101 for receiving terrestrial broadcasting is supplied to the tuners 1031 to 1038 via the input terminal 102. The terrestrial digital television broadcast signal processing modules of the tuners 1031 to 1038 select digital television broadcast signals on desired channels. The digital television broadcast signals selected by the tuners 1031 to 1038 are supplied to an orthogonal frequency division multiplexing (OFDM) demodulation module, which demodulates the broadcast signals into digital video signals and audio signals and then outputs the video and audio signals to the signal processing module 108.

The signal processing module 108 then selectively subjects the digital video and audio signals supplied from the OFDM demodulation module to a specific digital signal process and outputs the resulting signals to the graphic processing module 112 and audio processing module 114.

To the signal processing module 108, for example, four input terminals 104 to 107 are connected. The input terminals 104 to 107 enable analog video and audio signals to be input from outside the digital television broadcast receiver 1.

The signal processing module 108 selectively digitizes the analog video and audio signals supplied from the input terminals 104 to 107, subjects the digitized video and audio signals to a specific digital signal process, and then outputs the resulting signals to the graphic processing module 112 and audio processing module 114.

The graphic processing module 112 has the function of superimposing an on-screen display (OSD) signal generated by an OSD signal generation module 111 onto the digital video signal supplied from the signal processing module 108. The graphic processing module 112 can not only selectively output the output video signal from the signal processing module 108 and the output OSD signal from the OSD signal generation module 111 but also combine the two outputs so that each of them may constitute half of the screen and output the resulting signal.

The digital video signal output from the graphic processing module 112 is supplied to the video processing module 113. The video signal processed by the video processing module 113 is supplied to the image display unit 141. The image display unit 141 displays an image based on the video signal.

The audio processing module 114 converts the input digital audio signal into an analog audio signal in a format that can be reproduced by the speaker 142 and outputs the resulting signal to the speaker 142, which then reproduces sound.

In the digital television broadcast receiver 1, all of the operations, including the aforementioned various receiving operations, are comprehensively controlled by the controller 110. The controller 110, which comprises a central processing unit (CPU), receives operating information (various instructions) from the operation unit 115 or operating information (various instructions) sent from a remote controller 116 and received via a light-receiving unit 117 and controls the individual modules and others so that the nature of the operation may be reflected.

In addition, the controller 110 further comprises a read-only memory (ROM) 1101 which stores a control program executed by the CPU, a random access memory (RAM) 1102 which provides the CPU with a work area, and a nonvolatile memory 1103 in which various items of setting data and control data are stored.

The controller 110 is connected via a card interface 120 to a card holder 119 in which a memory card 118 can be installed. This enables the controller 110 to exchange data with the memory card 118 installed in the card holder 119 via the card interface 120.

The controller 110 is further connected to the LAN terminal 122 via the communication interface 122. This enables the controller 110 to exchange data via the communication interface 123 with a LAN-compatible device connected to the LAN terminal 21. In this case, the controller 110, which has a dynamic host configuration protocol (DHCP) server function, allocates an Internet protocol (IP) address to a LAN-compatible device connected to the LAN terminal 122 and controls the device.

The controller 110 is further connected to the HDMI terminal 128 via the HDMI interface 129. This enables the controller 110 to exchange data via the HDMI interface 129 with an HDMI-compatible device connected to the HDMI terminal 128.

The controller 110 is further connected to the USB terminal 124 via the USB interface 125. This enables the controller 110 to exchange data via the USB interface 125 with a USB-compatible device connected to the USB terminal 124.

The controller 110 is further connected to the iLINK terminal 126 via the iLINK interface 127. This enables the controller 110 to exchange data via the iLINK interface 127 with an iLINK-compatible device connected to the iLINK terminal 126.

Moreover, the controller 110 is configured to receive a brightness sense signal from the brightness sensor 121. This enables the controller 110 to control the brightness or the like of an image and a backlight on the basis of the brightness sense signal.

Furthermore, the controller 110 can control a video recording operation to record a broadcast signal selected and decrypted by the tuner unit 103 on an HDD or the like connected via the LAN terminal 122 or USB terminal 124. Since the tuner unit 103 includes tuners, it can record or display programs on channels. For example, the digital television broadcast receiver 1 can record all the programs for one week on channels with high-definition image quality. Such video recording is referred to as multiple simultaneous video recording. To realize the multiple simultaneous video recording, the digital television broadcast receiver 1 includes tuners corresponding to channels and further includes card slots into which decryption cards corresponding to the tuners are to be inserted in order to deal with encrypted broadcasting.

Next, the reception of content and display control of images (Web pages) corresponding to received content will be explained. Content is HTML files, GIF files, JPEG files, and the like stored in specific locations specified by addresses (URL information). An image corresponding to content is generated by at least a part of the data constituting the content. For example, if the content is an HTML file, an image corresponding to the content is an image (final screen display) which includes characters or control symbols generated on the basis of the analysis of the HTML file. If the content is a GIF file or a JPEG file, an image corresponding to the content is an image generated by decoding the GIF file or JPEG file. The digital television broadcast receiver 1 can communicate with an external server via the LAN terminal 122 and communication interface 123. That is, the digital television broadcast receiver 1 can receive content by specifying an address (URL information). The nonvolatile memory 1103 stores the specified address and received content. In addition, the digital television broadcast receiver 1 can receive instances of content sequentially by specifying addresses sequentially. The nonvolatile memory 1103 stores the addresses specified and the instances of content received.

Furthermore, the controller 110 has a browser function. The controller 110, OSD signal generation module 111, graphic processing module 112, and video processing module 113 can control the display of images (Web pages) corresponding to instances of content. According to the display control, the image display unit 141 displays images corresponding to instances of content.

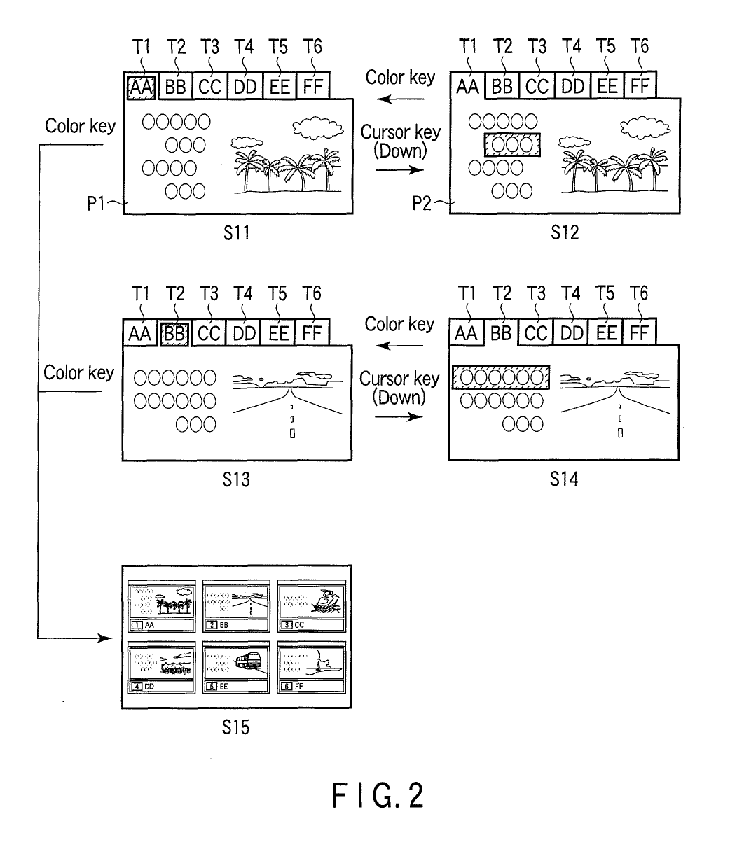

FIG. 2 shows display screens which separately display images corresponding to instances of content and a display screen which displays images in list form.

For example, when tab T1 on the screen is selected according to a color key operation (e.g., blue key operation) and a cursor operation on the remote control key 116 or the like, the controller 110, OSD signal generation module 111, graphic processing module 112, and video processing module 113 control the display of a first image (first Web page) corresponding to a first one of the instances of content. According to the display control (display control in a first display format), the image display unit 141 displays a display screen S11 shown in FIG. 2. That is, the image display unit 141 displays the first image. Moreover, according to a cursor key operation on the remote controller 116 or the like, each item in the first image can be selected (display screen S12 of FIG. 2).

Similarly, when tab T2 on the screen is selected according to a color key operation (e.g., blue key operation) and a cursor operation on the remote control key 116 or the like, the controller 110, OSD signal generation module 111, graphic processing module 112, and video processing module 113 control the display of a second image (second Web page) corresponding to a second one of the instances of content. According to the display control (display control in a second display format), the image display unit 141 displays a display screen S13 shown in FIG. 2. That is, the image display unit 141 displays the second image. Moreover, according to a cursor key operation on the remote controller 116 or the like, each item in the second image can be selected (display screen S14 of FIG. 2).

Similarly, when tab T3 is selected, a third image corresponding to a third one of the instances of content is displayed. When tab T4 is selected, a fourth image corresponding to a fourth one of the instances of content is displayed.

Furthermore, with display screen S11 or S13 of FIG. 2 being displayed, the controller 110, OSD signal generation module 111, graphic processing module 112, and video processing module 113 update display screen S11 (first display format) of FIG. 2 or display screen S13 (second display format) of FIG. 2 to a display screen S15 (third display format) of FIG. 2 according to one color key operation (blue key operation) on the remote controller 116 or the like.

Alternatively, with display screen S12 or S14 of FIG. 2 being displayed, the controller 110, OSD signal generation module 111, graphic processing module 112, and video processing module 113 update display screen S12 (first display format) of FIG. 2 or display screen S14 (second display format) of FIG. 2 to a display screen S15 (third display format) of FIG. 2 according to two color key operations (blue key operations) on the remote controller 116 or the like.

Display screens S11 and S13 of FIG. 2 are in a state where tabs T1 to T4 can be selected. Display screen S12 of FIG. 2 is in a state where the items on page P1 specified by tab T1 can be selected. Display screen S14 of FIG. 2 is in a state where the items on page P2 specified by tab T2 can be selected.

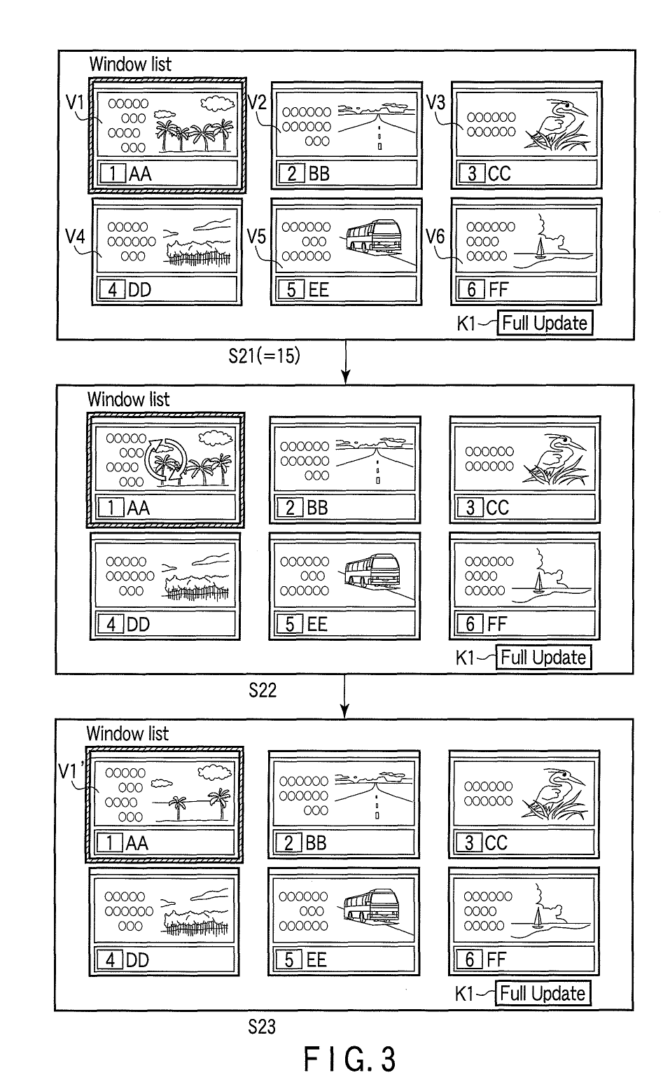

Display screen S15 of FIG. 2 is a display screen which displays images corresponding to instances of content in list form. Display screen S21 of FIG. 3 shows display screen S15 of FIG. 2 in more detail. The digital television broadcast receiver of the embodiment can update the selected one of the images (the Web pages) corresponding to the instances of content by selecting one of the images on display screen S21 shown in FIG. 3. In addition, the digital television broadcast receiver of the embodiment can update the images (the Web pages) corresponding to the instances of content sequentially by specifying Full Update key K1 on display screen S21 shown in FIG. 3.

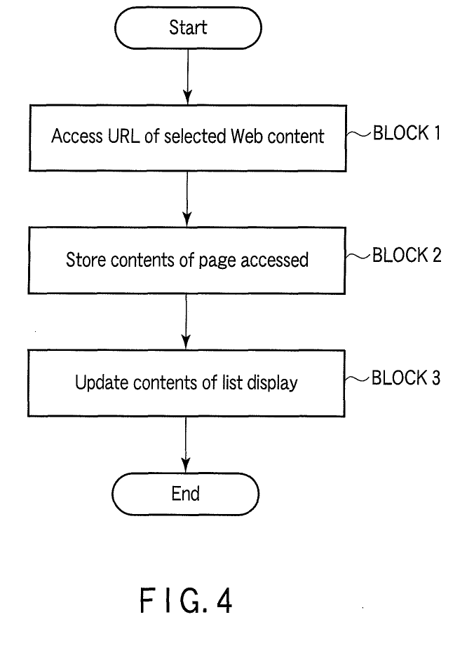

First, the update of the selected image will be explained. FIG. 4 is a flowchart to explain an example of the process of updating the selected image.

With display screen S21 of FIG. 3 being displayed, a first image V1 (first Web page) corresponding to first content is selected according to a cursor operation on the remote controller 116 or the like and the controller 110, LAN terminal 122, and communication interface 123 start to reacquire the first content on the basis of a first address corresponding to the first content according to a Decide key operation on the remote controller 116 or the like (BLOCK 1). At this time, the controller 110, OSD signal generation module 111, graphic processing module 112, and video processing module 113 update display screen S21 of FIG. 3 to display screen S22 of FIG. 3. When the first content has been reacquired, the nonvolatile memory 1103 stores the first content (BLOCK2) and the controller 110, OSD signal generation module 111, graphic processing module 112, and video processing module 113 update display screen S22 of FIG. 3 to display screen S23 of FIG. 3 (BLOCK3). Display screen S22 of FIG. 3 is a display screen which shows that the selected image in the list is being updated. The content obtained by the reacquisition is defined as first reacquisition content.

That is, the first image V1 (see display screen S21 of FIG. 3) in the list display is updated to a first reacquisition image V1′ (see display screen S22 of FIG. 3) corresponding to the first reacquisition content. This enables the digital television broadcast receiver to update the first image V1 to the latest one (the first reacquisition image V1′), while maintaining the list display. The user can see the latest one of the selected image, while viewing the list display.

As described above, the digital television broadcast receiver updates the selected image according to an image selecting operation. Alternatively, the digital television broadcast receiver may update each image automatically at regular intervals of time. In this case, the image selecting operation is unnecessary, which increases convenience.

Next, the update of all the images will be explained.

With display screen S21 of FIG. 3 being displayed, when Full Update key K1 is specified according to a color key operation (green key operation) on the remote controller 116 or the like, the controller 110, LAN terminal 122, and communication interface 123 start to reacquire instances of content on the basis of addresses corresponding to instances of content displayed in list form.

For example, the controller 110, LAN terminal 122, and communication interface 123 start to reacquire the first content on the basis of the first address corresponding to the first content included in the instances of content. At this time, the controller 110, OSD signal generation module 111, graphic processing module 112, and video processing module 113 update display screen S21 of FIG. 3 to display screen S22 of FIG. 3 and further update display screen S22 of FIG. 3 to display screen S23 of FIG. 3 after the reacquisition of the first content has been completed. That is, the first image V1 in the list display (see display screen S21 of FIG. 3) is updated to the first reacquisition image V1′ corresponding to the first reacquisition content (see display screen S22 of FIG. 3).

Then, the controller 110, LAN terminal 122, and communication interface 123 start to reacquire the second content on the basis of the second address corresponding to the second content included in the instances of content. After the reacquisition of the second content has been completed, the controller 110, OSD signal generation module 111, graphic processing module 112, and video processing module 113 update the second image V2 in the list display (see display screen S21 of FIG. 3) to the second reacquisition image corresponding to the first reacquisition content.

Similarly, the controller 110, LAN terminal 122, and communication interface 123 start to reacquire the third content on the basis of the third address corresponding to the third content included in the instances of content. After the reacquisition of the third content has been completed, the controller 110, OSD signal generation module 111, graphic processing module 112, and video processing module 113 update the third image V3 in the list display (see display screen S21 of FIG. 3) to the third reacquisition image corresponding to the third reacquisition content.

The controller 110, OSD signal generation module 111, graphic processing module 112, and video processing module 113 repeat the update process until all the images in the list display (first image V1 to sixth image V6) have been updated. This enables the digital television broadcast receiver to update all the images in the list display to the latest ones, while maintaining the list display.

Next, a case where the update process is applied to a favorites function will be explained. The favorites function acquires one or more instances of content on the basis of one or more addresses (URL information) entered and displays the acquired content. For example, when the nonvolatile memory 1103 stores one or more addresses entered and the execution of the favorites function is specified according to a key operation on the remote controller 116 or the like, the controller 110 sequentially receives instances of content on the basis of addresses entered and controls a list display of images corresponding to the instances of content. That is, as shown in display screen S21 of FIG. 3, images are displayed in list form. Thereafter, the controller 110, OSD signal generation module 111, graphic processing module 112, and video processing module 113, and LAN terminal 122 and communication interface 123 carry out the above-described process of updating the selected image or all the images.

Recently, digital television broadcast receivers have been provided with a browser function to make it possible to connect with an external network and watch and listen to Web content. The browser can manage instances of Web content simultaneously by use of tabs and selectively display images (pages) corresponding to the instances of Web content. For example, when a page corresponding to one instance of Web content has been selected, the Web content is reacquired and the contents of the page corresponding to the Web content are updated.

However, the Web content corresponding to pages that have not been selected for a long time is not reacquired. That is, the unselected pages are not updated. Accordingly, when images (pages) corresponding to instances of Web content are displayed in list form, the individual images are not necessarily the latest ones. For example, it is conceivable that, after a list display of Web content has been changed to a single display of Web content, the displayed Web content is updated. However, update in such steps is inefficient.

The digital television broadcast receiver of the embodiment can update the selected content or all the content, while displaying instances of Web content in list form. This enables the user to see the latest information on the selected content or all the content, while viewing a list display.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image receiving apparatus comprising:
a communication module configured to receive first content based on a first address and second content based on a second address by communicating with an external server;
a memory configured to store the first content and the second content;
a controller configured to control a list display of a first image corresponding to the first content and a second image corresponding to the second content; and
an update module configured to reacquire the first content based on the first address and to update the first image in the list display to a first reacquisition image corresponding to the first content reacquired.

2. The apparatus of claim 1, further comprising a selector configured to select one image in the list display,
wherein the update module is configured to reacquire the first content based on the first address corresponding to the first image selected by the selector and update the first image in the list display to the first reacquisition image corresponding to the first content reacquired.

3. The apparatus of claim 1, wherein the update module is configured to select the first address and the second address sequentially, to reacquire the first content based on the first address, to update the first image in the list display to the first reacquisition image corresponding to the first content reacquired, to reacquire the second content based on the second address, and to update the second image in the list display to a second reacquisition image corresponding to the second content reacquired.

4. The apparatus of claim 1, further comprising:
a specification module configured to specify an all-image update;
a selector configured to select one image from the list display,
wherein the update module is configured to reacquire the first content based on the first address corresponding to the first image selected by the selector and to update the first image in the list display to the first reacquisition image corresponding to the first content reacquired,
and the update module is further configured to select the first address and the second address sequentially according to the specification of the all-image update, to reacquire the first content based on the first address, to update the first image in the list display to the first reacquisition image corresponding to the first content reacquired, to reacquire the second content based on the second address, and to update the second image in the list display to a second reacquisition image corresponding to the second content reacquired.

5. The apparatus of claim 1, wherein the controller is configured to control display in a first display format in which a first image corresponding to the first content is displayed, a second display format in which a second image corresponding to the second content is displayed, or a third display format in which the first image and the second image are displayed in a list form, and
the update module is configured to reacquire the first content based on the first address according to the list display in the third display format and to update the first image in the list display to a first reacquisition image corresponding to the first content reacquired.

6. The apparatus of claim 5, wherein the update module is configured to select the first address and the second address sequentially according to the list display in the third display format, to reacquire the first content based on the first address, to update the first image in the list display to the first reacquisition image corresponding to the first content reacquired, to reacquire the second content based on the second address, and to update the second image in the list display to the second reacquisition image corresponding to the second content reacquired.

7. The apparatus of claim 1, further comprising a register configured to store the first address and the second address,
wherein the communication module is configured to receive the first content based on the first address stored by the register and the second content based on the second address stored by the register, and
the controller is configured to control a list display of the first image corresponding to the first content and the second image corresponding to the second content.

8. The apparatus of claim 1, further comprising a tuner configured to select a signal on a specified channel from received broadcast signals,
wherein the controller is configured to control image display based on the selected signal and the list display.

9. An image receiving method comprising:
receiving first content based on a first address and second content based on a second address by communicating with an external server;
storing the first content and the second content;
controlling a list display of a first image corresponding to the first content and a second image corresponding to the second content; and
reacquiring the first content based on the first address and updating the first image in the list display to a first reacquisition image corresponding to the first content reacquired.
